(19) United States
(12) Patent Application Publication
(10) Pub. No.: US 2025/0002365 A1
(43) Pub. Date: Jan. 2, 2025

(54) DYNAMIC DIALYSIS AS SCALABLE MANUFACTURING OF PURIFIED SURFACE ACTIVE MULTI-COMPONENT NANOPARTICLE PRODUCTION

(71) Applicant: UNIVERSITY OF CENTRAL FLORIDA RESEARCH FOUNDATION, INC., Orlando, FL (US)

(72) Inventors: Sudipta SEAL, Oviedo, FL (US); Craig NEAL, Orlando, FL (US); Elayaraja KOLANTHAI, Orlando, FL (US)

(21) Appl. No.: 18/646,475

(22) Filed: Apr. 25, 2024

Related U.S. Application Data
(60) Provisional application No. 63/461,760, filed on Apr. 25, 2023.

(51) Int. Cl. C01G 5/00; B01D 61/24; B82Y 40/00

(52) U.S. Cl. CPC C01G 5/006; B01D 61/243; B82Y 40/00; C01P 2002/84; C01P 2002/85; C01P 2004/04; C01P 2004/64

(57) ABSTRACT

Disclosed herein are methods of producing large batch metal/metal oxide nanoparticles that involve dynamic dialysis. The methods allow for batches of greater than 1 liter to be synthesized and aged while reducing the amount of water usage.

### STATEMENT OF FEDERAL FUNDING

This invention was made with government support under Grant No. 2032056 awarded by the National Science Foundation. The government has certain rights in the invention.

### BACKGROUND

Often, for metal oxide nanomaterial compositions employed in catalysis applications in aqueous environments, it is the less stable surface features (e.g., surface hydroxyls, surface hydrates, vacancy structures, etc.) which confer activity for the most desirable sets of reactions.

Scale up manufacturing of multi-component nanoparticles needs purification. Purification methods which apply substantial force to particle suspensions to isolate particle components may lead to loss or modification of these features (e.g., through de-hydration, re-construction, surface relaxation). Beyond affecting surface reactivity, modifications of surface character can affect particle aggregation, hydrophilicity, and adhesion energy, among other properties essential to material performance in application.

### BRIEF DESCRIPTION OF DRAWINGS

FIG. 1. Schematic: Large scale, High throughput wet chemical synthesis of AgCNP and extended to other metal/metal oxide system. (Top row) Particle synthesis optimization: design of reactor and reaction. (Bottom row) High volume, flow-thru dialysis: continuous removal of residual components; particle purification.

FIG. 2. Reaction Vessel (2.5 L) used for bulk AgCNPs synthesis.

FIG. 3. X-ray photoelectron spectroscopy of AgCNP with and without dynamic dialysis. Variation in cerium (FIG. 3A, FIG. 3C) and silver (FIG. 3B, FIG. 3D) chemical states were analyzed for control (FIG. 3A, FIG. 3B) and Dynamic Dialysis (FIG. 3C, FIG. 3D) samples. In comparing distribution of sample cerium phases into Ce³⁺ and Ce⁴⁺ states, we observed a greater proportion of oxidized states for the Dynamic Dialysis sample. Silver content for demonstrates sole presence of metallic state silver for both samples.

FIG. 4. High-resolution Transmission electron microscope (TEM) measurements. TEM images of Control (FIG. 4A) and Dynamic Dialysis (FIG. 4B) samples show crystalline character of particles as visible lattice fringes. Particles observed in Control sample appear largely similar to those analyzed from small batch (0.05 L) samples with an average particle size between 15 and 20 nm in diameter. Additionally, crystallites of silver and of cerium oxide character are observable as unique domains in a given particle. However, the observed ceria particles were of similar size (˜5 nm) to the ceria domains noted in small batch samples.

FIG. 5. System for Rapid synthesis and purification of AgCNPs at a scale-up level (1.5 liters). The AgCNPs nanoparticles were synthesized at 70° C. for 2 hours, subsequently, the nanoparticle synthesis reactor was connected to a dynamic dialysis system using a silicone tube. The AgCNPs solution was continuously circulated at a rate of 150 mL/min through a 3.5 kDa dialysis tube using peristatic pump. Simultaneously, pure water was continuously circulated at a rate of 300 mL/min in the dialysis tank using peristatic pump. The liquid flow was maintained in opposite directions for both the nanoparticles and the dialysis water, which facilitated a faster purification of the nanoparticles.

FIG. 6 AgCNPs nanoparticles were synthesized using force hydrolysis method at room temperature and aged for 8 weeks at dark environment. Then, the particles purified dynamic dialysis equipment and samples were collected different time point and measure the conductivity. The dialysis time vs conductivity is shown in the figure. The results showed that conductivity of AgCNPs solution decreased with increase in dialysis time.

FIG. 7. represents the relationship between the molecular weight cutoff (MWCO) in kDa of different dialysis tubes and the corresponding dialysis time in hour. The purpose of the dialysis process was to purify AgCNPs nanoparticles, which were synthesized using the force hydrolysis method at room temperature and aged for 8 weeks in a dark environment. To purify the AgCNPs nanoparticles, dynamic dialysis equipment was used along with various dialysis tubes with MWCOs of 3.5 kDa, 10 kDa, and 25 kDa. The dialysis process involved collecting samples at different time points and measuring the conductivity. When the conductivity of AgCNPs reached below 100 μS/cm, it was considered the saturation endpoint of purification. The results of the experiment indicated that the MWCO of the dialysis tube played a significant role in reducing the dialysis time. Presumably, higher MWCO dialysis tubes allowed for faster purification since they could selectively remove smaller-sized impurities from the nanoparticles

FIG. 8 illustrates the nanoparticle purification process using a dynamic dialysis system with varying water circulation speeds. The experiment maintained constant parameters for molecular weight cutoff (MWCO) at 3.5 kDa, dialysis water volume at 15 L, and the endpoint conductivity of nanoparticles at less than 100 μS/cm. As depicted in the figure, the purification time is plotted against the different water circulation speeds of 20 mL, 300 mL, 600 mL, and 1000 mL per minute. The results clearly demonstrate that higher water circulation speeds lead to a more rapid purification process. Overall, the data from FIG. 3 confirms that higher water circulation speeds, particularly 600 mL/min and 1000 mL/min, can effectively expedite the nanoparticle purification process in the dynamic dialysis system.

FIG. 9 displays the relationship between the volume of AgCNPs used in the purification process and the resulting conductivity after dialysis using a dynamic dialysis system with a constant water volume of 15 L and a dialysis tube of 0.8 meters. The data indicates that after the purification process, using 1.5 L of AgCNPs, the conductivity of the dialysis water was increased only to 134±6 μS/cm. This reduction in conductivity suggests that the purification process was successful in removing impurities and un-reacted products from the AgCNPs solution.

FIG. 10 illustrates the 0.5 litter of nanoparticle purification process using a dynamic dialysis system with parallel circulation both nanoparticles and dialysis water in opposite direction. The experiment maintained constant parameters for molecular weight cutoff (MWCO) at 3.5 kDa, dialysis water volume at 15 L, and the endpoint conductivity of nanoparticles at less than 100 μS/cm. As depicted in the figure, the purification time is plotted against conductivity (μS/cm). The results clearly demonstrate that parallel circulation of nanoparticles and dialysis water enhance the purification (10 hrs) as compared to only circulation with water (45 hrs).

FIG. 11 shows the 1.5-liters of AgCNP 1_T70_without aged (without ageing process) sample used a dynamic dialysis purification method with parallel circulation of both nanoparticles (flow rate 150 mL/min) and dialysis water (300 mL/min) in opposite direction. The experiment maintained constant parameters for molecular weight cutoff (MWCO) at 3.5 kDa, dialysis water volume at 15 L, and the endpoint conductivity of nanoparticles at less than 100 μS/cm. As depicted in the figure, the purification time is plotted against conductivity (μS/cm). The results clearly demonstrate that parallel circulation of nanoparticles and dialysis water enhance the purification (@ 22 hours) as compared to only circulation with water (@ 45 h).

FIG. 12 (a-d) UV-Vis spectrum of various condition synthesized AgCNPs before dialysis.

FIG. 13 (a-d). UV spectrum of various condition synthesized AgCNPs after dialysis. FIG. 13(a-d) shows the after dialysis of AgCNPs UV-Vis spectrum. The cerium oxide characteristic absorption peaks (Ce³⁺ (˜252 nm) and Ce⁴⁺ (˜300 nm)) didn't change after dialysis of all the condition samples. This result indicates that no structural change occurs during dialysis process as compared to before dialysis sample.

FIG. 14. Superoxide Dismutase (SOD) Activity measurements on synthesized AgCNPs. SOD activity was measured for positive control cerium oxide nanoparticle (CNP) formulation, AgCNP Control, and Dynamic Dialysis samples (all at 0.25 mM). All tested samples demonstrated substantial activity (seen as lower absorption up to 10 minutes, in the assay) with the Control sample showing significant activity over the positive control (CNP formulation).

### DETAILED DESCRIPTION

Disclosed herein is a new synthesis method of nanomaterial compositions that alleviates the need to use centrifugal force or flow shear separation. In particular, method embodiments disclosed herein utilize dynamic dialysis to achieve purification that preserves the character of sensitive surface features.

Often, for metal oxide nanomaterial compositions employed in catalysis applications in aqueous environments, it is the less stable surface features (e.g., surface hydroxyls, surface hydrates, vacancy structures, etc.) which confer activity for the most desirable sets of reactions.

Scale up manufacturing of multi-component nanoparticles needs purification. Purification methods which apply substantial force to particle suspensions to isolate particle components may lead to loss or modification of these features (e.g., through de-hydration, re-construction, surface relaxation). Beyond affecting surface reactivity, modifications of surface character can affect particle aggregation, hydrophilicity, and adhesion energy, among other properties essential to material performance in application. In place of such methods (e.g., using centrifugal force or flow shear), a method is disclosed that utilizes dynamical dialysis, which achieves a more gentle approach to purification in order to preserve the character of sensitive surface features.

In an exemplary embodiment, disclosed is a method of producing large batch metal/metal oxide nanoparticles that involves forming metal/metal oxide nanoparticles by mixing a metal precursor and a metal oxide precursor in a first container; and then ageing the metal/metal oxide nanoparticles, in situ, and then subjecting them to dialysis over a period of time to remove counterions and unreacted materials. The term “ageing” as used herein refers to subjecting metal/metal oxide components at solid evolution and precipitation state under conditions to promote formation of well-dispersed, suspended particles with an oxidizing agent (e.g. hydrogen peroxide, ammonium hydroxide, NaOH, KOH, dissolved oxygen) which may produce a chemical species adsorbed on the material surface that undergoes degradation over time (e.g., by a surface redox reaction from the ageing material). In a specific embodiment, dialysis comprises transferring the metal/metal oxide nanoparticles into a second container that has a size-specific permeable barrier. The second container is situated in a third container such that dialysate in the third container interacts with the size-specific permeable barrier comprising the walls of the second container. The third container has an inlet for infusing dialysate and an outlet for removing dialysate, wherein waste products in the second container pass through the size-specific permeable barrier into third container and are directed out of the third container via the outlet.

The terms “about” or “approximately” as used herein when referring to a measurable value such as a parameter, an amount, a temporal duration, and the like, are meant to encompass variations of and from the specified value, such as variations of +/−20% or less, +/−10% or less, +/−5% or less, +/−1% or less, and +/−0.1% or less of and from the specified value, insofar such variations are appropriate to perform in the disclosed invention. It is to be understood that the value to which the modifier “about” or “approximately” refers is itself also specifically, and preferably, disclosed.

In a specific embodiment, the size-specific permeable barrier blocks molecules above 12 kDa, above 8 kDa or above 3.5 kDa from passing therethrough. In a specific embodiment, the size-specific permeable barrier is comprised of cellulose (e.g. cellulose acetate). A permeable barrier is a material or membrane that allows certain substances to pass through while restricting the passage of others. The characteristics of a permeable barrier can vary depending on its intended use and application. Here are some general characteristics:
Pore Size: Permeable barriers have specific pore sizes that determine the size of particles or ions that can pass through. The pore size can range from nanometers to micrometers, and it can be adjusted based on the desired selectivity.
Ion Selectivity: Permeable barriers can be selective in terms of the types of ions that can pass through. Some barriers allow only certain ions to pass while blocking others based on their charge or size.
Permeability: Permeable barriers can have different levels of permeability, which determines the rate at which substances can pass through. This can be adjusted based on the intended application and the desired rate of diffusion or filtration.
Material Composition: Permeable barriers can be made from various materials, such as polymers, ceramics, metals, or composites. The material composition can affect the barrier's durability, chemical resistance, and overall performance.
Structural Integrity: Permeable barriers need to maintain their structural integrity under various conditions, such as pressure, temperature, and chemical exposure. The barrier should be stable and robust to ensure reliable performance.

Some examples of commercially available products that utilize permeable barriers include:
Reverse Osmosis (RO) Membranes: These membranes are commonly used in water purification systems and have small pore sizes that selectively allow water molecules to pass through while blocking larger ions, molecules, and contaminants.
Hemodialysis Membranes: These membranes are used in medical devices for kidney dialysis to selectively remove waste products and excess ions from blood while retaining essential molecules and ions.
Nanofiltration Membranes: These membranes have larger pore sizes compared to RO membranes and are used in applications such as water softening, color removal, and food processing, where selective ion removal is desired.
Microfiltration Membranes: These membranes have even larger pore sizes and are used in applications such as air filtration, sterile filtration of liquids, and protein separation, where larger particles or microorganisms need to be removed while allowing smaller molecules to pass through.
Controlled-Release Drug Delivery Systems: These systems use permeable barriers to control the release of drugs or other therapeutic agents from implants, patches, or other devices, allowing for a controlled and sustained release of the active ingredient over time.

Those skilled in the art will appreciate that other known materials for making selectively permeable barriers may be implemented, including but not limited to polysulfone membranes, polyamide membranes, polyamide-imide membranes, polyethersulfone membranes, polyimide membranes, polysulfone membranes, polyvinylidene fluoride membranes, and polyethyleneimine membranes.

The purification approach disclosed herein provides value in the catalysis, biomedical, and environmental industries:
Biomedical, catalysis: preservation of surface sites which are active towards relevant reactions
Environmental: removal of environmental toxins can occur by complexation to high energy surface sites; these sites may also be used for the catalytic degradation of environmental toxins

The technique is particularly suited for metal oxide particles of arbitrary composition dispersed in aqueous conditions that involve strong interactions between the material surface and dispersant molecules. High forces on these structures can promote reactions such as de-hydration, which, in turn, can change material redox states thereby leading to irreversible adhesion/aggregation between separate particles. While imposing less force on particle components, the disclosed methods sill achieve high-efficacy purification suitable for large scale manufacturing, requires only inexpensive equipment and resources, and permits some degree of selective purification by choice of membrane pore size.

### EXAMPLES

### Example 1: Experimental Considerations

Rationale: Large scale synthesis of AgCNPs (as an example) is accomplished by increasing batch volume, reactant concentration, and/or parallelizing sample processing. These modifications are accomplished through variation in relative reactant concentrations, changing reactor design, and/or by varying techniques for reactant introduction to the reactor.

### Main Considerations and Advantages of Implementing Dialysis in Ageing Process

Consideration(1): Decrease ageing time (time from solid evolution and precipitation to formation of well-dispersed, suspended particles with peroxide degraded by surface redox reaction)→Faster product collection
   Increase rate of hydrolysis and surface site redox
   Low pH produces particle products with unique surface chemistry with demonstrated biomedical value. However, low pH is less favorable for hydrolysis of metal ions to form metal oxides→increasing pH or providing additional external energy (temperature, microwave, hydrothermal) increases the rate of hydrolysis reactions.
   Metrics/Confirmation:
      Observable as change in solution (and precipitate) coloration from yellow-orange to colorless
      Can be confirmed through UV-Vis, XPS, visual inspection
Consideration(2): Must retain silver component in active form
   Reducing required time for complete ageing will require increasing kinetics of relevant physicochemical processes→need to characterize particle products to determine process improvements do not modify particle character.
   Metrics/Confirmation:
      Can be confirmed by TEM, XPS, enzyme-mimetic assay performance values
Consideration(3): Retain particle dispersity for final product
   Optimal particle size: ˜20 nm (largest axis measurement through silver and ceria domains)
   Particles spontaneously re-disperse from sediment into aqueous suspension in later stages of ageing. Optimization of re-dispersion process
      Hydrolysis evolves particle products and leads to decomposition of surface charge controlling ligand species (e.g., peroxy ligands, bridges)
      Stir rate increases surface area of less stable precipitate materials exposed to aqueous environment→potentially increasing reaction kinetics
   Metrics/Confirmation:
      Can be confirmed by Zeta potential measurements, visual observation
Consideration(4): Reduce waste of synthesis materials (e.g., water; cerium and silver precursor salts)
   Metal oxide (e.g. cerium oxide) and metal (e.g. silver) precursor concentrations can be optimized to prevent waste/unreacted component residue without altering particle product character
   Metrics/Confirmation: Can be confirmed by
      Solution conductivity measurements
      XPS, UV-Vis, DLS and TEM analysis

Approach: Initially, synthesis is performed at identical mole ratios to original synthesis protocols (Neal, C. J., Fox, C. R., Sakthivel, T. S., Kumar, U., Fu, Y., Drake, C., . . . & Seal, S. (2021), while solution components are increased by a linear sacling from 50 mL to liters. Briefly, AgCNP particles synthesis: 2180 mg of cerium nitrate hexa-hydrate (99.999% purity) was dissolved in 960 mL dH₂O in 2.5 L reaction reactor vessel. 5 mL of 0.2 M aq. AgNO3 (99% purity) was added to the cerium solution above with the solution vortexed. From here, 40 mL of 3% hydrogen peroxide was added quickly to the above solution followed by immediate stirred 500-1500 rpm for 15-60 min at room temperature using top head rotating stirrer. Solution was stored in dark condition at room temperature with the bottle cap loose to allow for release of evolved gases; solutions were left to age in these conditions for up to 6-8 weeks (monitoring solution color change from yellow to clear). Particles were then dialyzed (in cellulose dialysis tubing) in 10 L dynamic dialysis over 1 day and stored in the same conditions as for aging.

It is expected that additional studies with varying reactant ratios will compensate for variation in the synthesis environment (reactor design/character, flow/stirring conditions). However, the reaction has been designed to undergo uniform reaction and lead to homogenous particle formation. As an example, an oxidizer, such as, hydrogen peroxide is observed to react slowly with cerium nitrate precursors. This may allow optimal component mixing at large volumes without additional procedures for larger batch reactions. Based on findings, synthesis may be performed at larger volumes (2 to 3 L or more per batch) with relative reactant concentrations considered similar to those for studies at the lower volumes.

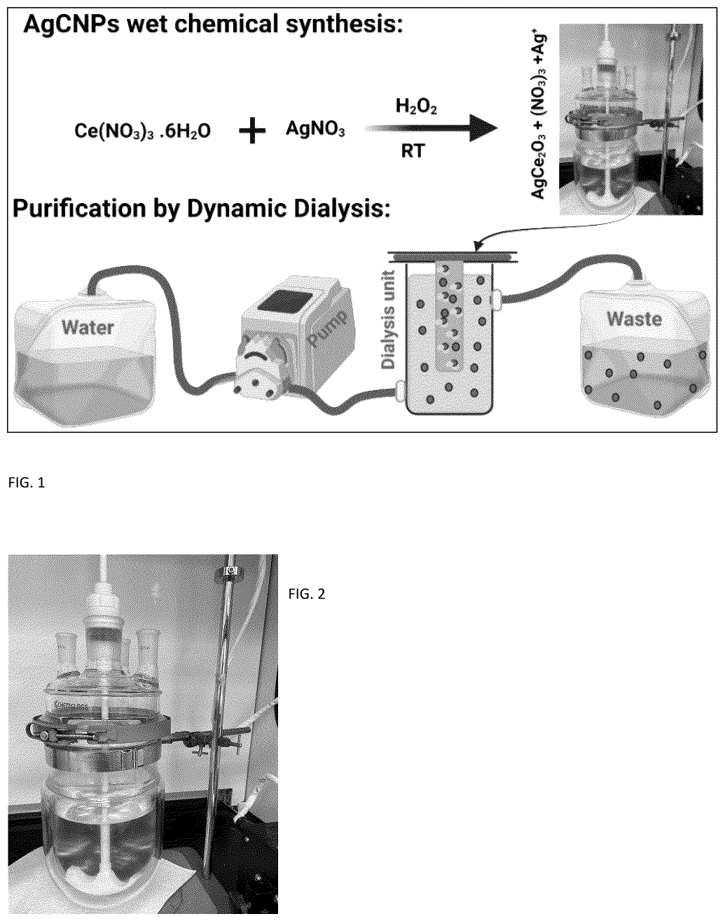

A dynamic dialysis process is used to make large scale batches and will allow purification to be performed over shorter time periods and at larger volumes (see FIG. 1) for scalable nanomanufacturing. The flow-through design can allow automated description of process endpoints such as incorporation of conductivity measurements of the dialysate. Dialysis is then performed until a desired dialysate conductivity is reached, decreasing time, expense, and limiting material loss. Based on the above synthesis modifications, various metal (Ag, Cu, Ni, etc.)/Metal Oxide (rare earth oxide (in lanthanide series, CeO₂, La₂O₃, etc) and transition metal oxides (ZnO, TiO₂, etc.) are synthesized at scales appropriate for larger batch production.

Similar conditions were applied for Ag concentration effect studies, pH effect study, and different treatment effect (synthesis condition same except temperature), see FIG. 2. The solution temperature was maintained at 70° C. and 120° C. during nanoparticles synthesis reaction. Particles are ultrasonicated prior to any further use.

### Example 2. Scalable Synthesis

Different approaches were conducted and effects of different synthesis conditions were evaluated (see Table 1 below): (i) Various Ag concentration on CNPs effect, (ii) pH effect, (iii) treatment effect (hydrothermal and microwave treatment), (iv) various temperature synthesis effect, (v) without aging process

### (i) Various Ag Concentration on CNPs Effect:

Initially, synthesis is performed at identical mole ratios to original synthesis protocols [1]. Briefly, AgCNPs particles synthesis: 1090 mg of cerium nitrate hexa-hydrate (99.999% purity) was dissolved in 478 mL dH₂O in 2.5 L reaction reactor vessel (FIG. 2). 2 mL of 0.25 M aq. AgNO₃ (99% purity) was added to the cerium solution above with the solution vortexed. From here, 20 mL of 3% hydrogen peroxide was added quickly to the above solution followed by immediate stirred 100 rpm for 15 min at room temperature using top head rotating stirrer (Eq. 1). After 15 min, the solution was transfer to glass bottle and store at dark environment for aging process. Similar, 1 mL and 0.2 mL of 0.25 M aq. AgNO₃ added to 479 ml and 479.8 mL cerium nitrate hexa-hydrate solution to get the another two more concentrations AgCNPs particles. 2 mL, 1 mL and 0.2 mL of 0.25 M aq. AgNO₃ mixed with CNPs samples were named as AgCNPs1, AgCNPs0.5, and AgCNPs0.1.

$$Ce ( NO 3 ) 3.6 H 2 O + Ag ( NO 3 ) 3.4 H2O + H 2 O 2 \to AgCe203 + ( NO3 ) 3 + Ag + … \qquad eq . 1$$

### (ii) pH Effect

AgCNPs was synthesized three different pH such as 2.5, 3.56 and 5 to study how pH effect the nano-crystallization and aging process. 1090 mg of cerium nitrate hexa-hydrate (99.999% purity) was dissolved in 478 mL dH₂O in 2.5 L reaction reactor vessel. 2 mL of 0.25 M aq. AgNO₃ (99% purity) was added to the cerium solution above with the solution vortexed. From here, 20 mL of 3% hydrogen peroxide was added quickly to the above solution followed by immediate stirred 100 rpm for 15 min at room temperature using top head rotating stirrer. Three different bottle, 0.5 L of AgCNPs particles were prepared without changing any recipe. The pH was 3.56 for as-synthesized AgCNPs. The pH was reduced to 2.5 from 3.56 using (concentration) nitric acid in one of the 0.5 L AgCNPs. Another 0.5 L AgCNPs, pH increased to 5 from 3.56 using sodium hydroxide (NaOH). After synthesis, the solution was transfer to glass bottle and store at dark environment for aging process. The pH 2.5, 3.56 and 5 of AgCNPs was AgCNPL_pH2.5, AgCNP1_pH3.5, and AgCNP1_pH5, respectively.

(iii) Treatment Effect (Hydrothermal Thermal and Microwave Irradiation)

1090 mg of cerium nitrate hexa-hydrate (99.999% purity) was dissolved in 478 mL dH₂O in 2.5 L reaction reactor vessel. 2 mL of 0.25 M aq. AgNO₃ (99% purity) was added to the cerium solution above with the solution vortexed. From here, 20 mL of 3% hydrogen peroxide was added quickly to the above solution followed by immediate reactor vessel kept inside the 70° C. pre-heated oil bath. The water-cooling condensation system was connected to reactor vessel to avoid the volume change. The solution was constantly stirred 100 rpm for 15 min at room temperature using top head rotating stirrer. Another batch of AgCNPs was synthesized without changing other parameter. One batch of nanoparticle were subjected to microwave irradiation using household microwave oven (power and Hz). Another batch of nanoparticles were transfer to hydrothermal synthesis reactor (hydrothermal bomb) and it's applied to 120° C. for 2 h. After treatments, the nanoparticles were transfer to glass bottle and incubated for aging process at room temperature. These nanoparticles were compared with untreated AgCNPs. No treatment, microwave irradiation and 120° C. hydrothermal treated nanoparticles were named as AgCNPs 1_No T, AgCNPs 1_MW and AgCNPs 1_HT120.

### (iv) Various Temperature Synthesis Effect

AgCNPs was synthesized at two different temperatures (70° C. and 120° C.) to study how temperature effect the nano-crystallization and aging process. 1090 mg of cerium nitrate hexa-hydrate (99.999% purity) was dissolved in 478 mL dH₂O in 2.5 L reaction reactor vessel. 2 mL of 0.25 M aq. AgNO₃ (99% purity) was added to the cerium solution above with the solution vortexed. From here, 20 mL of 3% hydrogen peroxide was added quickly to the above solution followed by immediate reactor vessel kept inside the 70° C. pre-heated oil bath. The water-cooling condensation system was connected to reactor vessel to avoid the volume change. The solution was constantly stirred 100 rpm for 15 min at 70° C. using top head rotating stirrer. Another batch of AgCNPs was synthesized at 120° C. without changing other parameter. After synthesis, both the batch of nanoparticles were transfer to separate glass bottle and incubated for aging process at room temperature. These nanoparticles compared with room temperature synthesized samples. Room temperature, 70° C. and 120° C. synthesized AgCNPs was AgCNPs 1_RT, AgCNPs 1_T70, and AgCNPs 1_T120.

### (v) Rapid Synthesis of AgCNPs (One Day Process)

Our goal in this experiment was to synthesis and purify AgCNPs in a one day without the aging process. To achieve this, 1434 mL of deionized water taken in 2.5 L three necks round bottom flash. The central neck was connected to a condenser unit to cool down the water vapor generated during the reaction. A thermometer was attached to one of the side necks, while the other one was sealed with a glass stopper. Next, the deionized water-containing round-bottom flask was immersed in an oil bath and heated to 70° C. Once the desired temperature was reached, we added 3270 mg of cerium nitrate hexa-hydrate (99.999% purity), which dissolved in the water. Subsequently, 6 mL of 0.25 M aqueous AgNO3 (99% purity) was introduced into the cerium solution, and the mixture was continuously stirred using a magnetic stirrer at a constant speed. At this point, we rapidly added 60 mL of 3% hydrogen peroxide to the solution. To prevent volume changes, we connected a water-cooling condensation system connected to round bottom flash. The solution was consistently stirred at 100 rpm for 2 hours at 70° C. After synthesis, the nanoparticles were allowed to cool down to room temperature for 1 hour. After cooling, thermometer was removed and attached conductivity meter one side of necks and other side of necks connected in/out silicon tube connected with dynamic dialysis device (FIG. 5). We dialyzed the nanoparticles against deionized water using a dynamic dialysis system. These nanoparticles were then compared with those that had undergone the aging process. We named this sample AgCNPs_T70_without aging.

TABLE 1
Physical changes observed during synthesis of the AgCNPs nanoparticle using
different approaches.

| S. | | | |
|---|---|---|---|
| no | Synthesis description | Sample code | Observation after synthesis |
| 1 | 1 mM of Ag added to 5 mM CNPs | AgCNPs_1 | Pale yellow after 5 minutes addition of |
| 2 | 0.5 mM of Ag added to 5 mM | AgCNPs_0.5 | oxidizer (H₂O₂) |
| | CNPs | | |
| 3 | 0.1 mM of Ag added to 5 mM | AgCNPs_0.1 | |
| | CNPs | | |
| 4 | 1 mM of Ag added to 5 mM CNPs- | AgCNPs1_pH 2.5 | Pale yellow AgCNPs 1 solution turned |
| | pH adjusted using nitric acid | | to milky color by reducing the pH 2.50 |
| | | | from 3.56. |
| 5 | 1 mM of Ag added to 5 mM CNPs- | AgCNPs1_ pH 5 | Pale yellow AgCNPs 1 turn to dark |
| | pH adjusted using sodium | | yellow solution by reducing the pH |
| | hydroxide | | 2.50 from 3.56. |
| 6 | 1 mM of Ag added to 5 mM CNPs- | AgCNPs 1_MW | Pale yellow AgCNPs 1 turn to dark |
| | microwave irradiation for 5 min | | yellow solution after 5 min microwave |
| | | | irradiation |
| 7 | 1 mM of Ag added to 5 mM CNPs- | AgCNPs 1_HT120 | Pale yellow AgCNPs 1 solution turned |
| | 120° C. hydrothermal treatment | | to milky color after 120° C. |
| | | | hydrothermal treatment |
| 8 | 1 mM of Ag added to 5 mM CNPs- | AgCNPs1_T120 | Milky color AgCNPs 1 solution was |
| | synthesized at 120° C. using | | obtained at this condition. |
| | condensation | | |
| 9 | 1 mM of Ag added to 5 mM | AgCNPs1_T70 | Very light pale yellow AgCNPs 1 |
| | CNPs- synthesized at 70° C. using | | solution was obtained at this condition. |
| | condensation | | |
| 10 | 1 mM of Ag added to 5 mM CNPs- | AgCNPs1_T70_ | Very light pale yellow AgCNPs 1 |
| | synthesized at 70° C. using | without aging | solution was obtained even after |
| | condensation (1.5 L without aging) | | dialysis. |

### Example 3: AgCNPs Nanoparticle Aging Process

All the condition synthesized nanoparticles were stored in dark condition at room temperature with the bottle cap loose to allow for release of evolved gases; solutions were left to age in these conditions for up to 6-8 weeks (monitoring solution color change from yellow to clear). The physical changes of synthesized nanoparticle in aqueous environment were observed every two weeks during the aging process see Table 2.

TABLE 2
Physical changes observed during synthesis of the AgCNPs nanoparticle using different approaches.

| Sample code | 1 & 2 weeks | 3&4 weeks | 5&6 weeks | 7&8 weeks |
|---|---|---|---|---|
| AgCNPs_1 | Pale yellow dense | Density of pale- | Light pale-yellow | white sediment |
| AgCNPs_0.5 | precipitates | yellow precipitate | fine sediment at | at bottom of |
| AgCNPs_0.1 | deposited at the | decreased at glass | bottom glass bottle. | glass bottle |
| | bottom of the glass | bottle bottom. | Sediment decreased | observed. The |
| | bottle | Sediment decreased | as compared to | clear NPs |
| | | as compared to | previous | solution obtained |
| | | previous | observation | after 20 min |
| | | observation | | sonication. |
| AgCNPs1_pH 2.5 | White dense | Glass bottle bottom | White sediment | |
| | precipitates | density of white | decreased to | |
| | deposited at the | particle decreased | previous | |
| | bottom of the glass | | observation | |
| | bottle | | | |
| AgCNPs1_pH 5 | Dark yellow dense | Density of pale- | Loose pale-yellow | Pale yellow |
| | precipitates at the | yellow precipitate | sediment observed | sediment at |
| | bottom of the glass | decreased at glass | | bottom of glass |
| | bottle | bottle bottom | | bottle observed. |
| | | | | The yellow |
| | | | | whites NPs |
| | | | | solution obtained |
| | | | | after 20 min |
| | | | | sonication. |
| AgCNPs | | | Still dark yellow | Color less very |
| 1_MW | | | sediment observed | fine sediment in |
| | | | at the bottom of | the bottom. The |
| | | | glass bottle | clear NPs |
| AgCNPs | Milky white dense | Milky white fine | Milky white fine | solution obtained |
| 1_HT120 | precipitates at the | sediment the | sediment in the | after 20 min |
| | bottom of the glass | bottom | bottom. It | sonication. |
| | bottle | | was | |
| | | | shaking by hand | |
| | | | turns to milky | |
| | | | solution. | |
| AgCNPs | Very light pale | Same to previous | Pale yellow | |
| 1_T70 | yellow dense | observation | precipitate | |
| | precipitates | | significantly | |
| | deposited at the | | decreased to | |
| | bottom of the glass | | previous | |
| | bottle | | observation | |
| AgCNPs | White dense | Milky white fine | Milky white fine | |
| 1_T120 | precipitates | sediment in the | sediment in the | |
| | deposited at the | bottom | bottom. It was | |
| | bottom of the glass | | shaking by hand | |
| | bottle | | turns to milky | |
| | | | solution. | |
| AgCNPs | — | — | — | — |
| 1_T70 without | | | | |
| aging | | | | |

### Example 4: Dynamic Dialysis Process

The silver ion effect, pH effect, various temperature synthesis, microwave, and hydrothermal treated AgCNPs were dialyzed (in cellulose dialysis tubing) in 10 L dynamic dialysis. (i) Various time interval samples were collected and the saturation point of conductivity was measured during the dialysis to determine when nanoparticles are completely purification occurs. In addition, other dialysis parameters were evaluated such as various MWCO dialysis tube, various speed of dialysis flow through, minimization of the water usage & dialysis tube and) parallel circulation of both nanoparticle and dialysis water.

### (i) Determination of Saturation Point of Conductivity

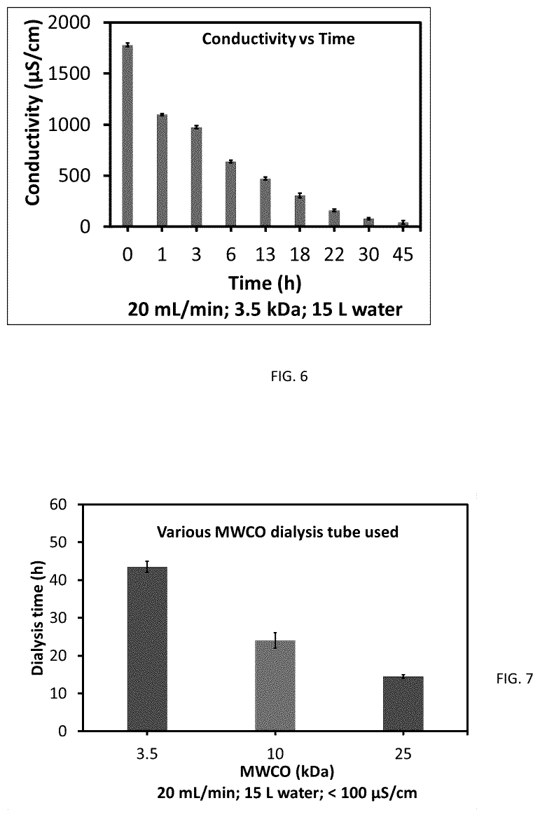

To determine the saturation endpoint of synthesized AgCNPs purification using conductivity measurement, aged AgCNPs 1 were transferred to a semi-permeable dialysis tube with molecular weight cutoff of 3.5 kDa. Dynamic dialysis equipment with a constant flow rate of water (20 mL/min) flow through the surrounding the dialysis tube was used for the dialysis process. In total, 15 L of deionized water was used for purifying 0.5 L of AgCNPs 1. Samples of the AgCNPs 1 were collected from dialysis tube at pre-determined time intervals, and the conductivity of each sample was measured. The results showed that the conductivity of the AgCNPs gradually decreased with the increase in dialysis time. The measured conductivity values (in μS/cm) were 1179, 1099, 976.6, 639.3, 470, 304, 158.74, 78.52, and 42.52 after 0, 1, 3, 6, 13, 18, 22, 30, and 45 hrs of dialysis, respectively (FIG. 6). We obtained the saturation of endpoint of AgCNPs purification at 45 hrs. Experiment was performed in triplicate to ensure accuracy, and the average values and standard deviation were used to plot the graph shown below:

### (ii) Various MWCO Dialysis Tube

We chose three different molecular weight cutoff (MWCO) such as 3.5, 10 and 25 kDa to find the right pore size of dialysis tube for nanoparticle purification. Aged AgCNPs 0.1, AgCNPs 0.5, AgCNPs 1 were transferred to a semi-permeable dialysis tube with molecular weight cutoff of 3.5 kDa (pore size ˜2 nm), 10 kDa (pore size ˜2.9 nm) and 25 kDa (pore size ˜4.2 nm) [2] dialyzed it with 20 mL/min constant flow through of water (FIG. 7). Every run of experiment 15 L of fresh water used for dynamic dialysis process. The conductivity was less than 100 in μS/cm reached at 45 (3.5 kDa), 24 (10 kDa) and 14 (25 kDa) hrs (FIG. 7). The results showed that increase the MWCO of dialysis tube increased the purification rate of nanoparticles (dialysis time reduced). This is due to the higher pore size in the 25 kDa dialysis membrane than 3.5 kDa. Overall, the findings suggest that the choice of dialysis tube with an appropriate MWCO is crucial for optimizing the purification process of AgCNPs nanoparticles.

(iii) Various Speed of Dialysis Flow Through

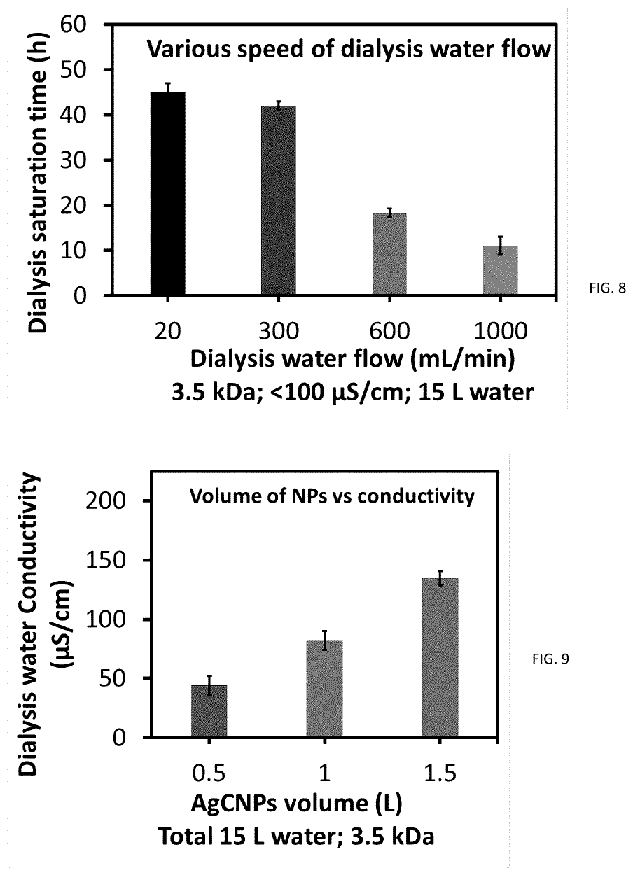

In the purification experiment, three types of aged AgCNPs (AgCNPs1, AgCNPs_pH5, and AgCNPs_MW) were used, and their purification process was investigated under different water circulation speeds surrounding the dialysis tube. The dialysis was carried out using a semi-permeable dialysis tube with a molecular weight cutoff of 3.5 kDa, and the dynamic dialysis system was set to have water circulation speeds of 20 mL, 300 mL, 600 mL, and 1000 mL per minute with a constant volume of 15 L water. Samples were collected from the dialysis tube at pre-determined time intervals, and the conductivity of each sample was measured until it reached less than 100 μS/cm, indicating successful purification. The results showed that the endpoint of nanoparticle purification was obtained at approximately 45±2 hrs for 20 mL/min and 18.5±2 hrs for 300 mL/min water circulation. Interestingly, there was no significant difference observed in the purification time between 20 mL/min and 300 mL/min water circulation speeds, suggesting that speeds up to 300 mL/min did not notably affect the purification rate (FIG. 8). However, when the water circulation speed was increased to 600 mL/min, the purification rate noticeably increased compared to the lower speeds. Moreover, further increasing the water circulation to 1000 mL/min resulted in an even faster purification rate compared to 600 mL/min. Based on these findings, it can be concluded that water circulation with high rpm, specifically 600 mL/min and 1000 mL/min, significantly reduces the time required for nanoparticle purification. Thus, higher water circulation speeds can be utilized to expedite the purification process effectively.

### (iv) Minimize the Water Usage & Dialysis Tube

The experiment aimed to determine the minimum usage of water and dialysis tube in the dynamic dialysis purification process. Three different AgCNPs samples: AgCNPs1_pH5, AgCNPs1_MW, and AgCNPs1_HT120 use for purification process. After purification of these nanoparticle measure the dialysis water conductivity to determine this water reuse for another batch of AgCNPs or not. First, the dialysis of AgCNPs1_pH5 was carried out using a semi-permeable dialysis tube with a molecular weight cutoff of 3.5 kDa. The dynamic dialysis system maintained constant water circulation speeds with a volume of 15 L water. The conductivity for dialysis water was measured to be 44±8 μS/cm (FIG. 9). Next, the dialysis tube was washed with deionized water, and AgCNPs 1_MW was added to the same dialysis tube. The purification process was performed using the same 15 L water in the dynamic dialysis equipment, and the saturation conductivity endpoint was achieved. The conductivity of the dialysis water was significantly increased to 82±8 μS/cm after AgCNPs1_MW purification. Following this, the purified nanoparticle, AgCNPs1_MW, was transferred to a new glass bottle, and the dialysis tube was again washed with deionized water. Finally, the third sample, AgCNPs1_HT120, was dialyzed using the same 15 L water and the same 3.5 kDa dialysis tube (which had been used twice before). The conductivity of the AgCNPs1_HT120 solution was further reduced, reaching a maximum value of 134±6 μS/cm after purification. Based on the results, it was demonstrated that the dynamic dialysis system, with only 15 L of water and a 0.8-meter of a 3.5 kDa dialysis tube, was sufficient to remove the un-reacted products of silver nitrate, nitrate, and hydrogen peroxide from 1.5 L of AgCNPs. This finding suggests an efficient and environmentally friendly method for nanoparticle purification, reducing water usage and minimizing waste.

### (v) Parallel Circulation of Both Nanoparticle and Dialysis Water.

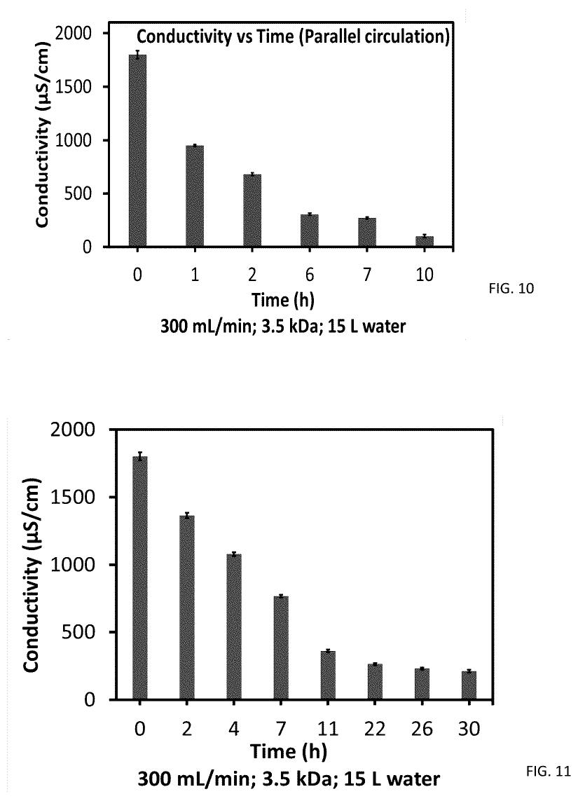

The experiment aimed to reduce the dialysis time of AgCNPs using parallel circulation of both nanoparticle and dialysis water using dynamic dialysis setup. AgCNPs1_T70, and AgCNPs 1_T120, samples were used for purification process. First, the dialysis of AgCNPs1_T70 was carried out using a semi-permeable dialysis tube with a molecular weight cutoff of 3.5 kDa. 150 mL/min of AgCNPs 1_T70 and AgCNPs 1_T120 nanoparticle was circulated inside the dialysis tube using external peristatic pumps. 15 liters of water circulated outside of the dialysis tube in the flow rate of 300 mL/min. Samples were collected from dialysis tube at pre-determined time intervals, and the conductivity of each sample was measured. The results showed that the conductivity of the AgCNPs gradually decreased with the increase in dialysis time. We obtained the saturation of endpoint of AgCNPs purification at 10 hrs. From these results, nanoparticle purification significantly decreased from 45 h (based on FIG. 6 observations) to 10 hrs by parallel circulation of water and nanoparticles using dynamic dialysis system. Experiment was performed in triplicate to ensure accuracy, and the average values and standard deviation were used to plot the graph shown in FIG. 10.

### (vi) Rapid Synthesized AgCNPs

The goal in this experiment was to synthesis and purify AgCNPs in a one day without the aging process. As described above, we synthesized the 1.5 litter of AgCNPs nanoparticles at 70° C. using three necks round bottom flash. After cooling, thermometer was removed and attached conductivity meter one side of necks and other side of necks connected in/out silicon tube connected with dynamic dialysis device (FIG. 5). We dialyzed the nanoparticles against deionized water using a dynamic dialysis system with parallel circulation both nanoparticles (flow rate—150 mL/min) and dialysis water (flow rate—300 mL/min) in opposite direction. The MWCO 3.5 kDA of dialysis tube and 15 L of deionized water was used for nanoparticles dialysis process. Samples were collected from dialysis tube at pre-determined time intervals, and the conductivity of each sample was measured. The results showed that the conductivity of the AgCNPs gradually decreased with the increase in dialysis time. We obtained the saturation of endpoint of AgCNPs purification reached between 11 to 22 hrs (FIG. 11). The dialysis time increased from 10 hrs to up to 22 hrs as compared to previous experiment. This time difference is due to increase AgCNPs volume from 0.5 to 1.5 litter in dynamic dialysis process with parallel circulation technique.

### Example 5: Characterization

### 5.1 Structural Analysis

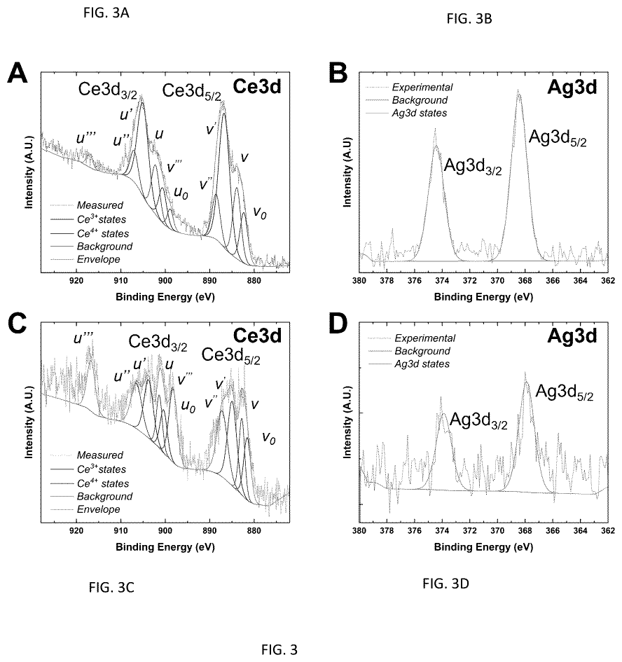

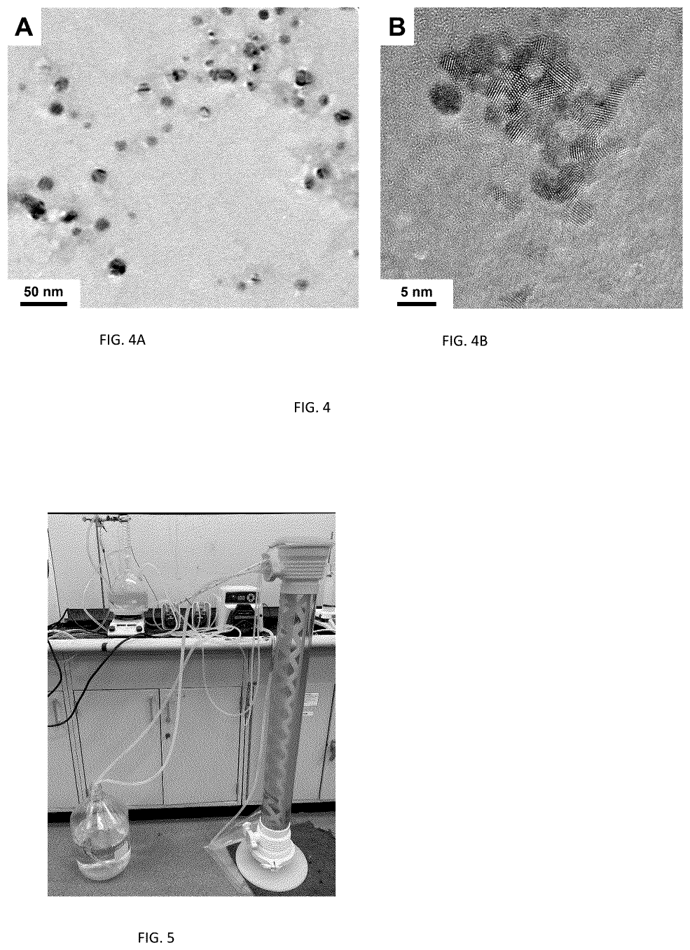

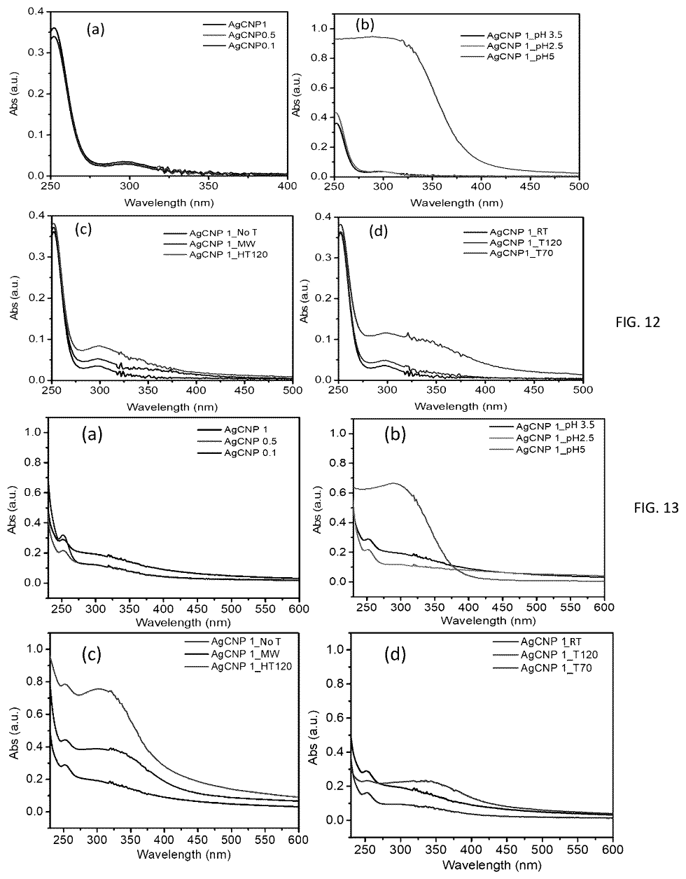

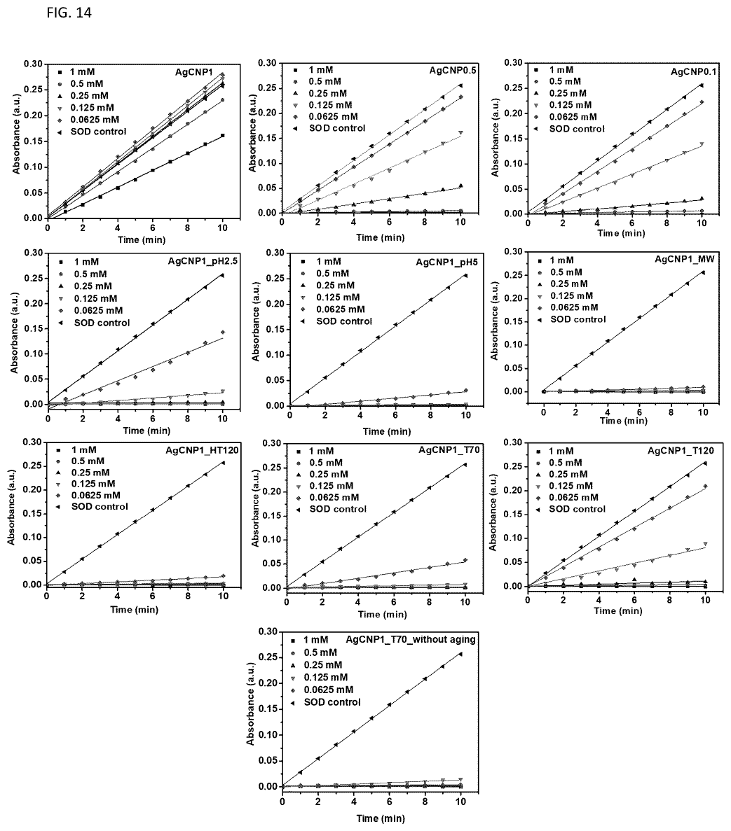

(i) UV-vis analysis: Both dialyzed and non-dialyzed synthesized AgCNPs samples were subjected to structural property analysis using UV-vis spectrophotometry. UV-vis spectra were acquired utilizing a PerkinElmer spectrophotometer within the 220 to 800 nm range at room temperature. FIG. 12 (a-d) shows UV-Vis spectrum of non-dialyzed AgCNPs sample. FIG. 3 shows x-ray spectroscopy data. The measured samples demonstrated distinct absorptions at Ce³⁺ (˜252 nm) and Ce⁴⁺ (˜300 nm) associated wavelengths. Upon reducing the silver content from 1 mm to 0.1 in the AgCNPs, the structural properties of the sample remained unchanged, as evidenced by the unaffected UV-Vis absorption spectrum (FIG. 12A). Additionally, AgCNPs were synthesized at various pH levels, and their UV-Vis spectra are displayed in FIG. 12B. Altering the pH from 3.5 to 2.5 did not cause any shift in the absorption peak. However, increasing the pH of AgCNPs to 5.0 resulted in a broad peak from 350 nm to 250 nm. This observation implies a predominant presence of the Ce⁴⁺ state within the cerium oxide structure. Notably, microwave and hydrothermal treatments did not induce modifications in the distinctive cerium oxide absorption peaks at 252 nm and 300 nm (FIG. 12C). Lastly, the impact of temperature on AgCNPs particles during synthesis was investigated. Remarkably, the characteristic absorption peaks of cerium oxide remained consistent, demonstrating no alterations (FIG. 12D). FIG. 15(a-d) shows the after dialysis of AgCNPs UV-Vis spectrum. The cerium oxide characteristic absorption peaks (Ce³⁺ (˜252 nm) and Ce⁴⁺ (˜300 nm)) didn't change after dialysis of all the condition samples. This result indicates that there is no structural change occurs during dialysis process as compared to before dialysis sample.

### 5.2. Enzyme-Mimetic Assay

The superoxide dismutase mimetic activity of AgCNPs under various conditions was assessed using a SOD assay kit-WST (Dojindo) following the manufacturer's instructions. In brief, AgCNPs concentrations ranging from 1 mM to 0.0625 mM were prepared for the SOD activity assay. To initiate the assay, 20 μL of the diluted AgCNPs samples were added to a 96-well culture plate, followed by the addition of 200 μL of WST working solution. SOD control (blank 1), sample blank (blank 2), and SOD control blank (blank 3) were prepared as controls. Subsequently, 20 μL of the enzyme working solution was added to the sample wells, blank 1, and blank 3. The absorbance was measured at 450 nm at room temperature using a microplate reader after the addition of the enzyme working solution. The SOD activity (inhibition rate %) was calculated from the obtained optical density values using the following equation.

$$SOD activity ( inhibition rate \% ) = [ ( Ablank 1 - Ablank 3 ) - ( Asample - Ablank 2 ) ] / \\ ( Ablank 1 - Ablank 3 ) * 100$$

FIG. 16 shows the kinetic studies of SOD activity. We have observed that the optical density (OD) value degreased with increase in concentration of AgCNPs. AgCNPs with synthesized different condition showed similar trends of SOD inhibition. From the kinetic studies, the percentage of SOD inhibition rate was calculated using above formula and results are tabulated in Table 3.

TABLE 3
SOD activity (inhibition rate %)
The SOD inhibition rate showed more than 90 % for 0.25 mM except AgCNPs 1, AgCNPs0.5 and
AgCNPs0.1 samples. AgCNPs 1 showed very less inhibition activity than other samples. This is
due to loss of nanoparticles during long run dialysis process.

| Sample Name | 0.0625 mM | 0.125mM | 0.25 mM | 0.5 mM | 1 mM |
|---|---|---|---|---|---|
| AgCNP 1 | 0 | 1.14 | 2.40 | 8.81 | 18.00 |
| AgCNP 0.5 | 11.49 | 41.37 | 80.84 | 97.70 | 98.85 |
| AgCNP 0.1 | 16.47 | 48.65 | 89.27 | 97.31 | 99.23 |
| AgCNP 1_pH2.5 | 51.34 | 91.57 | 98.08 | 99.61 | 99.82 |
| AgCNP 1_pH5 | 89.65 | 98.46 | 99.23 | 99.73 | 99.79 |
| AgCNP 1_MW | 96.55 | 98.85 | 98.85 | 99.57 | 99.73 |
| AgCNP 1_HT120 | 93.48 | 98.08 | 98.47 | 99.23 | 99.84 |
| AgCNP 1_T120 | 21.45 | 68.96 | 95.78 | 98.46 | 99.98 |
| AgCNP 1_T70 | 79.69 | 96.93 | 98.85 | 99.23 | 99.29 |
| AgCNP 1_T70 | 92.08 | 95.01 | 98.85 | 99.23 | 99.80 |
| without aging | | | | | |

### REFERENCES

[1] C. J. Neal, C. R. Fox, T. S. Sakthivel, U. Kumar, Y. Fu, C. Drake, G. D. Parks, S. Seal, Metal-Mediated Nanoscale Cerium Oxide Inactivates Human Coronavirus and Rhinovirus by Surface Disruption, ACS Nano 15(9) (2021) 14544-14556.
[2] L. Guo, P. H. Santschi, Ultrafiltration and its applications to sampling and characterisation of aquatic colloids, IUPAC Series on Analytical and Physical Chemistry of Environmental Systems 10 (2007) 159.

1. A method of producing large batch metal/metal oxide nanoparticles, the method comprising
a) forming metal/metal oxide nanoparticles by mixing a metal precursor and a metal oxide precursor in a first container; and
b) ageing the metal/metal oxide nanoparticles by subjecting the metal/metal oxide nanoparticles to dialysis,
wherein the dialysis comprises disposing the metal/metal oxide nanoparticles into a second container comprising a size-specific permeable barrier, the second container being situated in a third container such that dialysate in the third container interacts with the size-specific permeable barrier, the third container comprising an inlet for infusing dialysate and an outlet for removing dialysate, and wherein waste products in the second container pass through the size-specific permeable barrier into third container and are directed out of the third container via the outlet.

2. The method of claim 2, wherein the size-specific permeable barrier blocks molecules above 12 kDa, above 8 kDa or above 3.5 kDa from passing therethrough, and wherein the size-specific permeable barrier is optionally comprised of cellulose.

3. The method of claim 1, wherein an oxidizing agent is mixed with the metal precursor and metal oxide precursor during the forming step.

4. The method of claim 1, wherein the metal precursor comprises a salt of silver, gold, copper, platinum, nickel, iron, titanium, ruthenium, vanadanium and the like, wherein the salt is optionally a nitrate, or wherein the metal precursor is optionally, AgNO₃.

5. The method of claim 1, wherein the metal oxide precursor comprises a salt of a lanthanide, wherein the salt is optionally a nitrate, or wherein the metal oxide precursor salt is, optionally, a cerium salt, wherein the cerium salt is optionally cerium nitrate hexa-hydrate.

6. The method of claim 1, wherein the molar ratio of the metal precursor to the metal oxide precursor is 0.5-1.5:0.5-1.5 moles.

7. The method of claim 6, wherein the molar ratio is about 1:1.

8. The method of claim 1, wherein the mixing is conducted in a volume of at least 1 liter.

9. The method of claim 8, wherein the volume is 2-5 liters.

10. The method of claim 9, wherein the dialysate comprises water.

11. The method of claim 1, wherein the ageing step comprises about 12 to about 168 hours, or 12 to 96 hours, or 12 to 72 hours.

12. The method of claim 1, further comprising adjusting the pH of the second container over time to control hydrolysis of the metal/metal oxide nanoparticles.

13. The method of claim 12, wherein adjusting the pH comprises increasing pH toward 7.0 to increase rate of metal ion and/or hydrated metal oxide hydrolysis.

14. The method of claim 1, further comprising increasing temperature and/or pressure in the second container to increase rate of metal ion and/or hydrated metal oxide hydrolysis.

15. The method of claim 1, wherein the pH of mixture in the first container is between about 2.0 to about 5.5, optionally, about 2.5 to about 5.

16. The method of claim 1, wherein the metal precursor is at a concentration of between about 0.1 to about 5 mM, optionally between about 0.1 to about 1 mM

17. The method of claim 1, further comprising subjecting the metal precursor and metal oxide precursor to radiation, optionally microwave radiation, during forming.

18. Nanoparticles produced by the method of claim 1.
